(19) United States
(12) Patent Application Publication
(10) Pub. No.: US 2013/0160856 A1
(43) Pub. Date: Jun. 27, 2013

(54) MULTI-PORT INJECTOR SYSTEM AND METHOD

(71) Applicants: Krishnakumar Venkatesan, Clifton Park, NY (US); Ali Ergut, Houston, TX (US); Ertan Yilmaz, Glenville, NY (US)

(72) Inventors: Krishnakumar Venkatesan, Clifton Park, NY (US); Ali Ergut, Houston, TX (US); Ertan Yilmaz, Glenville, NY (US)

(73) Assignee: GENERAL ELECTRIC COMPANY, SCHENECTADY, NY (US)

(21) Appl. No.: 13/334,265

(22) Filed: Dec. 22, 2011

(51) Int. Cl. F02M 63/00; F17D 1/00

(52) U.S. Cl. 137/1; 239/533.2

(57) ABSTRACT

A feed injector system includes an injector nozzle. The injector nozzle includes a first injector port assembly having a first injector port located at a center of a longitudinal axis of the injector nozzle and defining a flow path for directing a first feed flow from a respective source into a reaction zone. The feed injector system also includes a second injector port assembly having one or more second injector passages arranged about a first circumference of the first injector port for receiving and injecting a second feed flow. Further, the feed injector system includes a third injector port assembly having a plurality of third ports arranged about a second circumference of the first injector port. The third ports are communicatively coupled to a plurality of toroidal flow paths and configured to receive and inject a third feed flow.

### BACKGROUND

The field of the invention relates generally to injectors and more specifically to injectors in gasification systems.

In gasification systems, a fuel mixture is converted into partially oxidized gas (syngas) in a gasifier (or “reaction zone”). The partially oxidized gas may then be used to produce chemicals or, in the case of an integrated gasification combined-cycle (IGCC) power generation system, may be supplied to a combustor of a gas turbine for generating electrical power for supply to a power grid, for example. Exhaust from the gas turbine engines may be supplied to a heat recovery steam generator that generates steam for driving a steam turbine. Power generated by the steam turbine may also be provided to the power grid. The fuels as well as other materials to be mixed, such as air, oxygen, liquid, water, steam, slag additives, slurry additives, or combinations thereof, are typically injected into the gasifier or reaction zone through a feed injector that couples the feed sources to a feed nozzle. At least some of the feed sources traverse the feed injector separately and are joined together in the reaction zone downstream of the nozzle. Quick mixing of all of the sources is important for the reaction to complete in the short time the sources are in residence in the reaction zone.

Some known gasification feed injectors are designed for spraying the feed components at high velocity to encourage atomization, however such methods reduce the reaction time available and tend to inhibit a complete reaction. Other dry feed injector systems may include multiple ports for solid fuel injection in combination with oxidizer ports. The injector tip is similar to that of a showerhead and the solid and gas fuel mixture is split into small quantities along various flow paths inside the injector. Because of the distribution of the solid into multiple streams, the mixing time for the smaller quantity of fuel is very short, sometimes leading to insufficient mixing.

Accordingly, it is desirable to have injector systems that allow optimal mixing of the flow feed for improved gasifier efficiency.

### BRIEF DESCRIPTION

In accordance with an embodiment of the invention, a feed injector system is provided. The feed injector system includes an injector nozzle comprising a first injector port assembly comprising a first injector port located at a center of a longitudinal axis of the injector nozzle and defining a flow path for directing a first feed flow from a respective source into a reaction zone. The feed injector system also includes a second injector port assembly comprising a plurality of second injector ports arranged about a first circumference of the first injector port, wherein the plurality of second injector ports is configured to receive and inject a second feed flow. Further, the feed injector system includes a third injector port assembly comprising a plurality of third ports arranged about a second circumference of the first injector port, wherein the plurality of third ports are communicatively coupled to a plurality of toroidal flow paths and configured to receive and inject a third feed flow.

In accordance with another embodiment of the invention, a feed injector system is provided. The feed injector system includes an injector nozzle comprising a first injector port assembly comprising a first injector port located at a center of a longitudinal axis of the injector nozzle and defining a flow path for directing a first feed flow from a respective source into a reaction zone. The feed injector system also includes a second injector port assembly comprising one or more annular channels arranged concentrically about the first injector port, wherein the one or more annular channels are configured to direct a second feed flow from the respective source into the reaction zone and a third injector port assembly comprising a plurality of third ports arranged about a second circumference of the first injector port, wherein the plurality of third ports are communicatively coupled to a plurality of toroidal flow paths and configured to receive and inject a third feed flow.

In accordance with an embodiment of the invention, a method of feeding fuel into a reaction zone is provided. The method includes injecting individual streams of at least one of fuel and carrier gas or oxidizer through a first injector port centrally positioned in a tip of an injector nozzle into the reaction zone. The method also includes injecting a stream of fuel, slurry, oxidizer, or combinations thereof through one or more second injector ports arranged concentrically about a longitudinal axis of the first injector port into the reaction zone. Further, the method includes injecting a stream of oxygen through a plurality of third ports arranged about a first circumference of the first injector port into the reaction zone.

### DRAWINGS

These and other features, aspects, and advantages of the present invention will become better understood when the following detailed description is read with reference to the accompanying drawings in which like characters represent like parts throughout the drawings, wherein:

FIG. 1 is a side elevation view of a multi-port feed injector system in accordance with an embodiment of the present invention.

FIG. 2 illustrates an axial view of a face of the multi-port feed injector system shown in FIG. 1.

FIG. 3 is a side elevation view of a multi-port feed injector system in accordance with another embodiment of the present invention.

FIG. 4 illustrates an axial view of a face of the multi-port feed injector system shown in FIG. 3.

FIG. 5 is a side elevation view of a multi-port feed injector system in accordance with yet another embodiment of the present invention.

FIG. 6 illustrates an axial view of a face of the multi-port feed injector system shown in FIG. 5.

FIG. 7 is a schematic diagram of an integrated gasification combined-cycle (IGCC) power generation system in accordance with an exemplary embodiment of the present invention.

### DETAILED DESCRIPTION

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Further, the terms “gasifier” and “reaction zone” are used interchangeably. Any examples of operating parameters are not exclusive of other parameters of the disclosed embodiments.

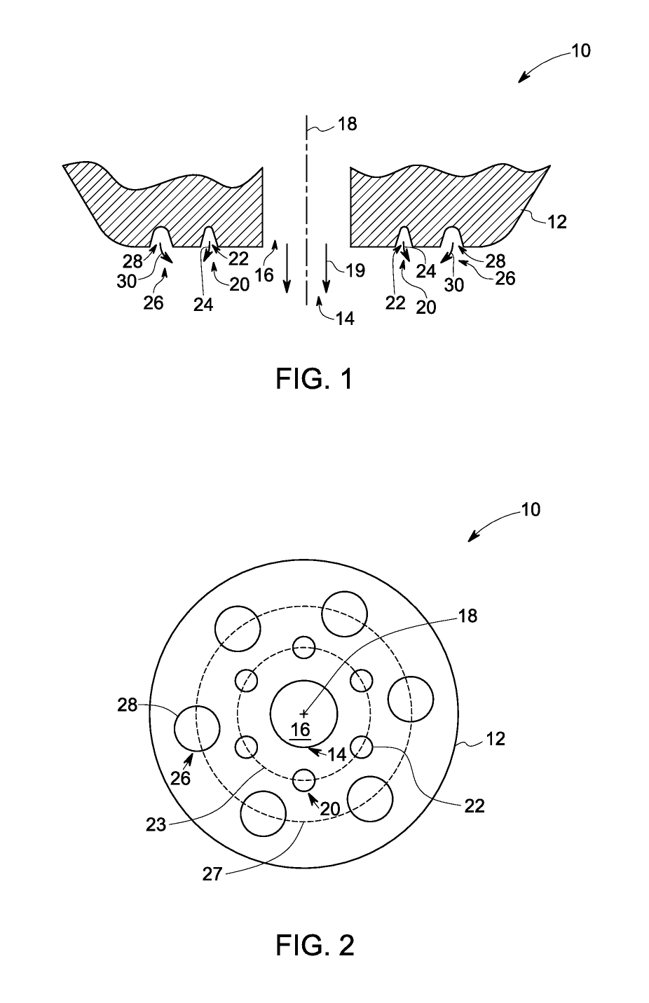

FIG. 1 is a side elevation view of a multi-port feed injector system 10 in accordance with an embodiment of the present invention. In the exemplary embodiment, the multi-port feed injector system 10 includes an injector nozzle 12 that includes a first injector port assembly 14. The first injector port assembly 14 includes a first injector port 16 located at a center of a longitudinal axis 18 of the injector nozzle 12 and defining a flow path for directing a first feed flow 19 from a respective source into a reaction zone. In one embodiment, the first feed flow 19 may include a feed flow comprising solid fuel such as coal, conveyance gas, slurry, oxygen or moderator gas or liquid, or combinations thereof. In a preferred embodiment, the first feed flow 19 comprises coal and conveyance gas or oxygen. The injector nozzle 12 also includes a second injector port assembly 20 comprising one or more second injector ports 22 for injecting a second feed flow 24. In one embodiment, the second feed flow 24 may include a feed flow comprising solid fuel such as coal, conveyance gas, slurry, oxygen or moderator gas or liquid, or combinations thereof. In a preferred embodiment, the second feed flow 24 comprises slurry or oxygen, wherein the slurry comprises a mixture of water and unburnt coal collected from the bottom of the reaction zone. The injector nozzle 12 further includes a third injector port assembly 26 comprising a plurality of third ports 28 for injecting a third feed flow 30. In one embodiment, the third feed flow 30 may include a feed flow comprising solid fuel such as coal, conveyance gas, slurry, oxygen or moderator gas or liquid, or combinations thereof. In a preferred embodiment, the third feed flow 30 comprises oxygen.

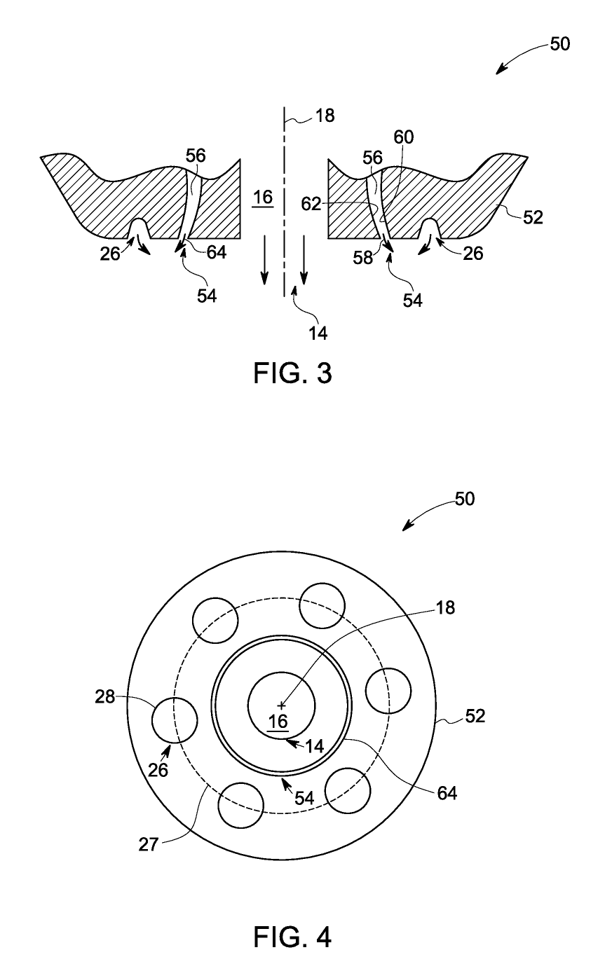

FIG. 2 illustrates an axial view of a face of the multi-port feed injector system 10 shown in FIG. 1. As shown, the injector nozzle 12 with the first injector port assembly 14 includes the first injector port 16 located at the center of the longitudinal axis 18. The second injector port assembly 20 includes the one or more second injector ports 22 arranged about a first circumference 23 of the first injector port 16. In this embodiment, as shown the one or more injector ports 22 are a plurality of separate ports arranged about the first circumference 23 of the first injector port 16. In another embodiment, the one or more injector ports 22 include one or more annular channels or ring ports shown in FIGS. 3-6. The second feed flow 24 through the plurality of separate ports of the second injector port assembly 20 may be controlled by control valves (not shown). In a more specific embodiment, the valves are opened and closed in a manner such that the feed flow rate is varied alternately for enhancing the mixing of the feed during injection into the gasifier. For example, in one embodiment, while operating the valves at every other port 22 (or non-adjacent ports) are opened at a first time period and then closed at a second time period during which the remaining valves are opened. This method is analogous to that employed for tuning of the fuel nozzles in a gas turbine.

The injector nozzle 12 also includes the third injector port assembly 26 comprising the plurality of third ports 28 arranged about a second circumference 27 of the first injector port 16. The plurality of third ports 28 are communicatively coupled to a plurality of toroidal flow paths and configured to receive and inject the third feed flow 30 (as shown in FIG. 1). In one specific embodiment, the third feed flow 30 comprises a flow of oxygen. In this embodiment, the plurality of toroidal flow paths may be further configured to channel the flow of oxygen through the plurality of third ports 28 such that the flow of oxygen is discharged from the plurality of third ports 28 having an axial flow component, a radially inward flow component, and a circumferential flow component. In one embodiment, the exit injection angles at the plurality of third ports 28 determine the radial and axial flow components of the flow of oxygen. Varying the exit injection angles between a selection of holes facilitates a wide control of the mixing behavior. By varying the exit injection angles between adjacent holes (stagger holes), oxygen emanating from each hole can be forced to reach a specific axial location at various time intervals which can be constructively employed to enhance mixing. Specifically, in one embodiment, all the holes are divided into three sections such that holes of the same angle are not adjacent to each other to provide a large range for varying the flow pattern exiting the injector. In another embodiment, the plurality of third flow ports 28 are controlled to inject oxygen at varied angles. Further, the third feed flow 30 may be controlled by control valves (not shown) in a similar manner as discussed above with respect to the second injector ports 22. It is to be noted that the injector nozzle 12 is typically cylindrical in shape and each of the first injector port 16 or the one or more second injector ports 22 or the plurality of third ports 28 may be circular or non-circular in shape.

FIG. 3 is a side elevation view of a multi-port feed injector system 50 in accordance with another embodiment of the present invention. The multi-port feed injector system 50 includes an injector nozzle 52 that includes the first injector port assembly 14 as shown FIG. 1 and FIG. 2. The injector nozzle 52 further includes a second injector port assembly 54 comprising one annular channel 56 arranged concentrically about the first injector port 16, wherein the one annular channel 56 directs a second feed flow 58 from a respective source into the reaction zone. In one embodiment, the second feed flow 58 may include a feed flow comprising solid fuel such as coal, conveyance gas, slurry, oxygen or moderator gas or liquid, or combinations thereof. In a preferred embodiment, the second flow 58 comprises slurry or coal or oxygen, wherein the slurry comprises a mixture coal, unburnt coal collected from bottom of the reaction zone, slag additive and/or pure water. The injector nozzle 52 further includes a third injector port assembly 26 as shown FIG. 1 and FIG. 2.

In this embodiment, the one annular channel 56 includes a first conduit that is cylindrically shaped located about the longitudinal axis 18. The annular channel 56 includes a radially outer surface 60 and a radially inner surface 62. Further, the annular channel 56 comprises a supply end (not shown), a discharge port end 64 and a length extending therebetween. In one embodiment, as shown, the discharge port end 64 includes a chamfered discharge end.

FIG. 4 illustrates an axial view of a face of the multi-port feed injector system 50 as shown in FIG. 3. The discharge port end 64 of the annular channel 56 is shown. The conduit of the annular channel 56 may include a slot or tube for carrying slurry or coal or oxygen.

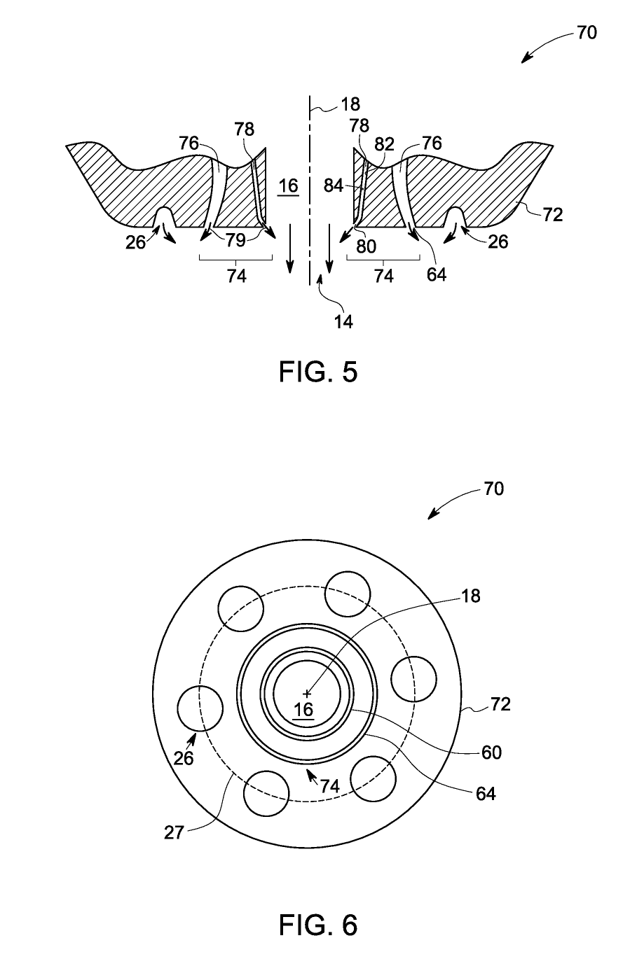

FIG. 5 is a side elevation view of a multi-port feed injector system 70 in accordance with yet another embodiment of the present invention. The multi-port feed injector system 70 includes an injector nozzle 72 that includes the first injector port assembly 14 as shown FIG. 1 and FIG. 2. The multi-port feed injector system 70 includes a second injector port assembly 74. The second injector port assembly 74 includes a first annular channel 76 and a second annular channel 78 arranged concentrically about the first injector port 16 as shown in FIG. 1 and FIG. 2. The second injector port assembly 74 is configured to inject a second feed flow from a respective source into a reaction zone. In one embodiment, the second feed flow 79 may include a feed flow comprising solid fuel such as coal, conveyance gas, slurry, oxygen or moderator gas or liquid, or combinations thereof. In a preferred embodiment, the second flow 79 comprises slurry or coal or oxygen, wherein the slurry comprises a coal, unburnt coal collected from bottom of the reaction zone, slag additive and/or pure water. The first annular channel 76 is similar to the annular channel 56 with the first conduit as shown in FIG. 3 and FIG. 4.

Further, the second annular channel 78 may include a second conduit at least partially surrounding and substantially concentrically aligned with the first conduit. The second annular channel 78 is cylindrically shaped about the longitudinal axis 18, and further includes a radially outer surface 82 and a radially inner surface 84. The second annular channel 78 further comprises a supply end (not shown), a discharge port end 80, and a length extending therebetween. In the embodiment shown in FIG. 5, the discharge port end 80 is angled inwards at the first injector port 16 to form a radially converging discharge end. Both the first annular channel 76 and the second annular channel 78 may be controlled using a plurality of valves (not shown). The injector nozzle 72 further includes a third injector port assembly 26 as shown FIG. 1 and FIG. 2. FIG. 6 illustrates an axial view of a face of the multi-port feed injector system 70 shown in FIG. 5 having the second injector port assembly 74. Further the first injector port 16 may be flushed with the second injector port assembly 74 or it can be retracted inside discharge port end 80.

FIG. 6 illustrates an axial view of a face of the multi-port feed injector system 70 as shown in FIG. 5. The discharge port ends 64 and 60 of the annular channel 74 are shown. The conduit of the annular channel 74 may include a slot or tube for carrying slurry or coal or oxygen.

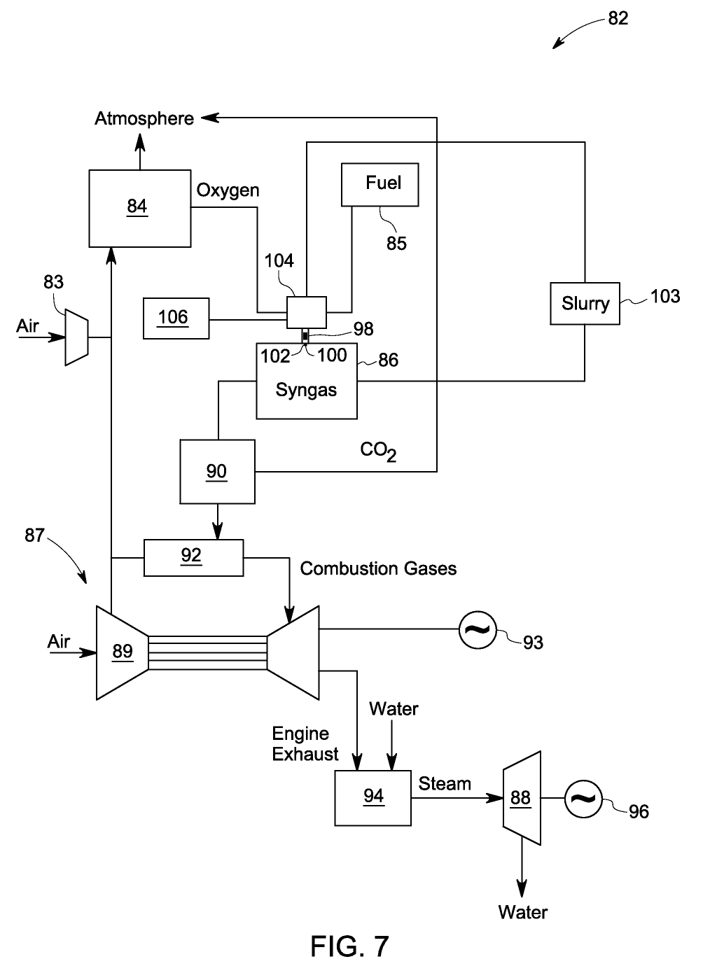

FIG. 7 is a schematic diagram of an integrated gasification combined-cycle (IGCC) power generation system 82 in accordance with an exemplary embodiment of the present invention. In the exemplary embodiment, IGCC system 82 includes a main air compressor 83, an air separation unit 84 coupled in flow communication to the main air compressor 83, a reaction zone 86 coupled in flow communication to air separation unit 84, a gas turbine engine 87 coupled in flow communication to the reaction zone 86, and a steam turbine 88. In operation, compressor 83 compresses ambient air. The compressed air is channeled to air separation unit 84. In some embodiments, in addition or alternative to compressor 83, compressed air from gas turbine engine compressor 89 is supplied to air separation unit 84. Air separation unit 84 uses the compressed air to generate oxygen for use in gasification reactions inside the reaction zone 86. More specifically, air separation unit 84 separates the compressed air into separate flows of oxygen and a gas by-product, sometimes referred to as a “process gas”. The oxygen flow is channeled to the reaction zone 86 for use in generating partially combusted gases, referred to herein as “syngas” for use by gas turbine engine 87 as fuel, as described below in more detail.

The reaction zone 86 converts a mixture of fuel, the oxygen supplied by air separation unit 84, steam, and/or limestone, conveyance gas, moderator gas into an output of syngas for use by gas turbine engine 87 as fuel. Although the reaction zone 86 may use any fuel, in some known IGCC systems 82, the reaction zone 86 uses coal, petroleum coke, residual oil, oil emulsions, tar sands, and/or other similar fuels from a feedstock 85. In some known IGCC systems 82, the syngas generated by reaction zone 86 includes carbon dioxide. The syngas generated by reaction zone 86 may be cleaned in a clean-up device 90 before being channeled to gas turbine engine combustor 92 for combustion thereof. Carbon dioxide may be separated from the syngas during clean-up and, in some known IGCC systems 82, vented to the atmosphere. The power output from gas turbine engine 87 drives a generator 93 that supplies electrical power to a power grid (not shown). Exhaust gas from gas turbine engine 87 is supplied to a heat recovery steam generator 94 that generates steam for driving steam turbine 88. Power generated by steam turbine 88 drives an electrical generator 96 that provides electrical power to the power grid. In some known IGCC systems 82, steam from the heat recovery steam generator 94 is supplied to reaction zone 86 for generating the syngas. In other known IGCC systems 82, thermal energy produced from the generation of syngas is used to generate additional steam for driving steam turbine 88.

In the exemplary embodiment, reaction zone 86 includes an injection nozzle 98 (similar to injection nozzle 12 of FIG. 1, FIG. 2 or injection nozzle 52 of FIG. 3, FIG. 4 or injection nozzle 72 of FIG. 5, FIG. 6) extending through reaction zone 86. Injection nozzle 98 includes a nozzle tip 100 at a distal end 102 of injection nozzle 98. The injection nozzle 98 may receive feedstock from unit 85, oxygen from unit 84, and slurry from unit 103, for example. The slurry unit 103, one a more specific embodiment, prepares slurry by mixing fuel, unburned carbon received from the reaction zone 86, slag additive and/or pure water from a water source. In one embodiment, the injector nozzle 98 may also receive steam from the heat recovery steam generator 94 or other sources. In another embodiment, the injector nozzle 98 may receive a moderator gas such as carbondioxide, nitrogen or steam or conveyance gases along with the fuel from the feedstock 85 or other sources (not shown). In one embodiment, the IGCC system 82 also includes a controller 106 for controlling a plurality of valves 104 that operate a plurality of ports including the first injector port, one or more second injector passages and the plurality of third injector ports as discussed in FIG. 1 to FIG. 6.

Advantageously, the present method and system of feeding fuel into a gasifier injector provides a cost-effective and reliable means for facilitating optimal mixing for a relatively high carbon conversion, which subsequently improves total gasifier efficiency and may facilitate increasing an overall IGCC plant efficiency. More specifically, the methods and systems described herein facilitate controlling various fuel and oxidizer flows to assist in optimizing mixing across a wide range of flow conditions using multiple knobs provided by the injector. In addition, the above-described method and system facilitates providing a broader and more uniform mixing profile owing to injection at multiple locations. As a result, the method and system described herein facilitate mixing and feeding fuel and oxidizer into a gasifier in a cost-effective and reliable manner.

Furthermore, the skilled artisan will recognize the interchangeability of various features from different embodiments. Similarly, the various method steps and features described, as well as other known equivalents for each such methods and feature, can be mixed and matched by one of ordinary skill in this art to construct additional assemblies and techniques in accordance with principles of this disclosure. Of course, it is to be understood that not necessarily all such objects or advantages described above may be achieved in accordance with any particular embodiment. Thus, for example, those skilled in the art will recognize that the assemblies and techniques described herein may be embodied or carried out in a manner that achieves or optimizes one advantage or group of advantages as taught herein without necessarily achieving other objects or advantages as may be taught or suggested herein.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A feed injector system comprising:
an injector nozzle comprising
a first injector port assembly comprising a first injector port located at a center of a longitudinal axis of the injector nozzle and defining a flow path for directing a first feed flow from a respective source into a reaction zone;
a second injector port assembly comprising a plurality of second injector ports arranged about a first circumference of the first injector port, wherein the plurality of second injector ports are configured to receive and inject a second feed flow; and
a third injector port assembly comprising a plurality of third ports arranged about a second circumference of the first injector port, wherein the plurality of third ports are communicatively coupled to a plurality of toroidal flow paths and configured to receive and inject a third feed flow.

2. The system of claim 1, further comprising control valves and a controller for sending signals to the control valves for operating two sets of the plurality of second injector ports alternatively for mixing the first feed flow, the second feed flow and the third feed flow.

3. The system of claim 2, wherein the controller is configured for sending signals to the control valves for operating two sets of the plurality of third ports alternatively for mixing the third feed flow with the first feed flow and the second feed flow.

4. The system of claim 1, wherein the first feed flow, the second, and the third feed flow independently comprise fuel, conveyance gas, slurry, water, oxygen or moderator gas or liquid, or combinations thereof, wherein the fuel comprises coal, petroleum coke, residual oil, oil emulsions, tar sands, biofuel or combinations thereof.

5. The system of claim 4, wherein the first feed flow comprises coal and conveyance gas or oxygen.

6. The system of claim 4, wherein the second feed flow comprises slurry or oxygen, wherein the slurry comprises a mixture of coal, unburnt coal collected from bottom of the reaction zone, slag additive and/or pure water.

7. The system of claim 1, wherein the plurality of toroidal flow paths are further configured to channel a flow of oxygen through the plurality of third ports such that the flow of oxygen is discharged from the plurality of third ports having an axial flow component, a radially inward flow component, and a circumferential flow component.

8. A feed injector system comprising:
an injector nozzle comprising a first injector port assembly comprising a first injector port located at a center of a longitudinal axis of the injector nozzle and defining a flow path for directing a first feed flow from a respective source into a reaction zone;
a second injector port assembly comprising one or more annular channels arranged concentrically about the first injector port, wherein the one or more annular channels are configured to direct a second feed flow from the respective source into the reaction zone; and
a third injector port assembly comprising a plurality of third ports arranged about a second circumference of the first injector port, wherein the plurality of third ports are communicatively coupled to a plurality of toroidal flow paths and configured to receive and inject a third feed flow.

9. The system of claim 8, further comprising a controller for controlling the flow of feed flow through the second injector port assembly and the third injector port assembly.

10. The system of claim 8, wherein the one or more annular channels comprises: a first conduit substantially cylindrically shaped and located about the longitudinal axis, said first conduit comprising a supply end, a discharge end, and a length extending therebetween.

11. The system of claim 10, wherein said discharge end comprises a chamfered discharge end.

12. The system of claim 10, wherein the one or more annular channels comprises: a second conduit at least partially surrounding and concentrically aligned with said first conduit.

13. The system of claim 12, wherein said second conduit comprises a radially converging discharge end.

14. The system of claim 12, wherein said first and second conduits comprise discharge ends which are not at the same plane.

15. A method of feeding fuel into a reaction zone, said method comprising:
injecting individual streams of at least one of fuel and carrier gas, slurry or oxidizer through a first injector port centrally positioned in a tip of an injector nozzle into the reaction zone;
injecting a stream of fuel or slurry or oxidizer or combinations thereof through one or more second injector passages arranged concentrically in a first circumference about a longitudinal axis of the first injector port into the reaction zone; and
injecting a stream of oxygen through a plurality of third ports arranged about a second circumference of the first injector port into the reaction zone.

16. The method of claim 15, wherein the injecting a stream of oxygen comprises channeling a stream of oxidizer through a plurality of toroidal injector passages coupled in flow communication with the plurality of third ports.

17. The method of claim 15, wherein the one or more second injector passages are coupled in flow communication with a plurality of separate ports arranged about the second circumferences about the first injector port.

18. The method of claim 17, further comprising controlling a plurality of first control valves used for operating two sets of the plurality of separate ports alternatively for mixing the first feed flow, the second feed flow and the third feed flow.

19. The method of claim 15, wherein the one or more second injector passages are coupled in flow communication with one or more annular channels arranged concentrically about the longitudinal axis of the main injector port.

20. The method of claim 15, further comprising controlling a plurality of second control valves used for operating two sets of the plurality of third ports alternatively for mixing the third feed flow with the first feed flow and the second feed flow.
